(19) United States
(12) Patent Application Publication
(10) Pub. No.: US 2025/0251296 A1
(43) Pub. Date: Aug. 7, 2025

(54) METHOD OF PAYLOAD ESTIMATION AND ROBOT ARM SYSTEM AND ELECTRONIC DEVICE USING THE SAME

(71) Applicant: Delta Electronics, Inc., Taoyuan City (TW)

(72) Inventors: YU CHI LI, Taoyuan City (TW); YI CHANG CHEN, Taoyuan City (TW)

(21) Appl. No.: 18/822,328

(22) Filed: Sep. 2, 2024

(30) Foreign Application Priority Data
Feb. 7, 2024 (CN) 202410171858.8

(51) Int. Cl. G01M 1/10; B25J 19/02; G01M 1/12

(52) U.S. Cl. CPC G01M 1/10; B25J 19/02; G01M 1/122

(57) ABSTRACT

A method of payload estimation and a robot arm system and an electronic device using the same are disclosed for acquiring inertial parameters of a payload. The method comprises calculating a payload mass, merely rotating a forth joint of the robot arm system to calculate an equivalent moment of inertia of the payload, merely rotating a second joint to measure data for dynamic equations of a fourth joint, repeating at least two times to obtain at least two sets of the dynamic parameters to calculate a center of mass of the payload, and substituting the payload mass, the equivalent moment of inertia and the center of mass into an equation of parallel axis theorem to obtain a moment of inertia of the payload. The center of mass is calculated by solving two dynamic equations associated with the fourth joint, thus the computation complexity of the payload inertial parameters is reduced.

### CROSS REFERENCE TO RELATED APPLICATIONS

This application claims priority to Chinese Patent Application No. 202410171858.8, filed Feb. 7, 2024, the entire contents of which are incorporated herein by reference.

### FIELD OF DISCLOSURE

The present disclosure relates to a payload estimation method and a robot arm system and an electronic device using the same, and in particular to a payload estimation method, system, and an electronic device for a horizontal multi-joint robot arm system.

### BACKGROUND

The Selective Compliance Assembly Robot Arm (SCARA) features a multi-joint design that allows it to operate in both two-dimensional and three-dimensional spaces. In addition to the mechanical parameters of the robot arm itself, the inertial parameters of the payload also impact the performance of the robot arm system. The inertial parameters of the payload include the payload mass, the center of mass, and the moment of inertia. Deviations in the inertial parameters of the payload can lead to incorrect motor gains for the robot arm, causing shaking during operation. Furthermore, different payloads will case different performance limitations of the system, incorrect inertial parameters of the payload could increase the risk of mechanical damage or prevent the robot arm system from achieving its performance level. Typically, the inertial parameters of the payload can be obtained through Computer Aided Design (CAD) programs, and the manufacturer of the robot arm system also typically provide user interfaces for user to input these parameters. However, not all users are familiar with how to set these parameters, and practically it is hard to completely avoid user input error. Therefore, there is a need for a robot arm system to have payload estimation functionality to prevent user input error and ensure optimal performance.

### SUMMARY OF DISCLOSURE

Given this, the present disclosure provides a method for payload estimation and the robot arm system and the electronic device thereof. The inertia parameters of the payload can be effectively estimated by merely involving the dynamic equations of the fourth joint, which has the advantage of simplifying the calculation and reducing the risk of incorrect human input.

In one aspect, the present disclosure provides a payload estimation method for a robot arm system, which comprises a first robot arm, a second robot arm, a spline shaft, a first joint, a second joint, a third joint, and a fourth joint, and the spline shaft is used to carry a payload. The method comprises the following steps: (a) calculating or receiving a payload mass; (b) rotating merely the fourth joint to drive the spline shaft and payload to rotation, in order to measure the equivalent moment of inertia of the payload associated with the fourth joint; (c) rotating merely the second joint or simultaneously rotating both the first and second joints, to measure the dynamic parameters of the payload associated with the fourth joint, and repeating step (c) at least two times to obtain at least two sets of dynamic parameters; (d) substituting at least two sets of dynamic parameters into the corresponding dynamic equations of the fourth joint, resulting in at least two equations of the center of mass for calculating the center of mass of the payload; and (e) calculating the moment of inertia of the payload based on the payload mass, the equivalent moment of inertia, and the center of mass.

In another aspect, the present disclosure provides a robot arm system including a base, a first robot arm, a second robot arm, a spline shaft, a third joint, a fourth joint, and a control unit. One end of the first robot arm is pivotally connected to the base through the first joint. One end of the second robot arm is pivotally connected to the other end of the first robot arm through the second joint. The spline shaft is installed at the other end of the second robot arm, and an end of the spline shaft is used to carry a payload. The third joint is used to control the height of the spline shaft, and the fourth joint is used to rotate the spline shaft. The control unit is configured to execute the payload estimation method described above.

In another aspect, the present disclosure provides an electronic device comprising a control unit; and a memory coupled to the control unit, configured to store a program code that instructs the control unit to execute the payload estimation method as described above.

The payload estimation method of the present disclosure, and the robot arm system and electronic device thereof, has the following advantages: (1) It can automatically estimate the payload mass, the center of mass, and the moment of inertia of the payload, no matter whether the payload mass is known or unknown. This not only prevents user input errors but also ensures that the robot arm system can perform optimally; (2) Experimental results show that by only involve the dynamic equations of the most distal joint (such as the fourth joint), the accuracy of estimating the center of mass is higher, and it can also simplify the calculation complexity of the inertia parameters; (3) When the angle of the fourth joint differs by 45 degrees or more, it can reduce the correlation between the two sets of dynamic parameters, leading to better estimation results.

### BRIEF DESCRIPTION OF DRAWINGS

FIG. 1 illustrates a schematic diagram of a robot arm system according to an embodiment of the present disclosure.

FIG. 2 illustrates a flowchart of a payload estimation method according to an embodiment of the present disclosure.

FIG. 3 illustrates a functional block diagram of the robot arm system according to an embodiment of the present disclosure.

### DETAILED DESCRIPTION

The exemplary embodiments of the present disclosure will now be elaborated upon with reference to the accompanying drawings. However, it should be noted that these exemplary embodiments can take many forms and should not be interpreted as being confined to the embodiments set forth herein. Instead, these embodiments are provided to ensure that this disclosure is comprehensive and thorough, and effectively communicates the full scope of the disclosure to those skilled in the art. The drawings are merely schematic illustrations of the disclosure, and the components depicted in the drawings are not necessarily drawn to scale. Identical reference numerals in the drawings denote identical or similar parts, hence, repeated descriptions thereof will be omitted for brevity.

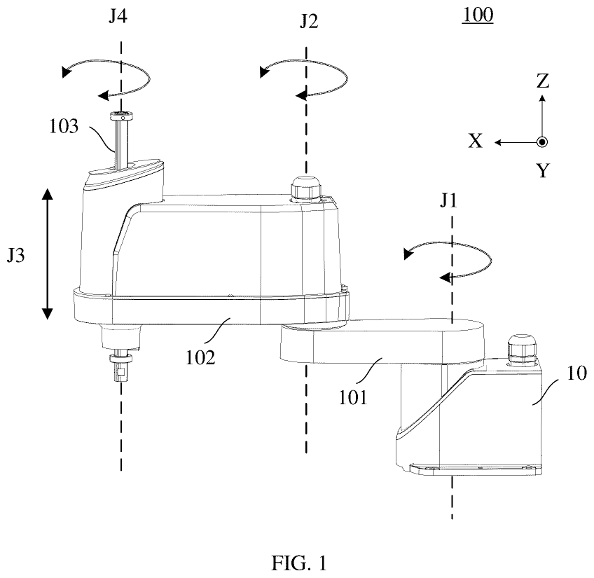

Please refer to FIG. 1, which illustrates a schematic diagram of a robot arm system 100 according to an embodiment of the present disclosure. The robot arm system 100 can be a Selective Compliance Assembly Robot Arm (SCARA), and comprises a base 10, a first robot arm 101, a second robot arm 102, a spline shaft 103, and a plurality of joints J1, J2, J3, J4. The first robot arm 101 is pivotally connected to the base 10 at the joint J1, and the motor inside the joint J1 (not shown in FIG. 1) is used to drive the first robot arm 101 to rotate to a specific angle relative to the base 10 in the XY plane according to control signals. The second robot arm 102 is pivotally connected to the first robot arm 101 at the joint J2, and the motor inside joint J2 is used to drive the second robot arm 102 to rotate to a specific angle relative to the first robot arm 101 according to control signals. The joint J3 is a sliding joint, and the motor inside joint J3 is used to drive the spline shaft 103 to move along the Z direction according to control signals. The motor inside joint J4 is used to drive the spline shaft 103 to rotate to a specific angle relative to the second robot arm 102 according to control signals. The spline shaft 103 can be installed with an end effector to carry a payload.

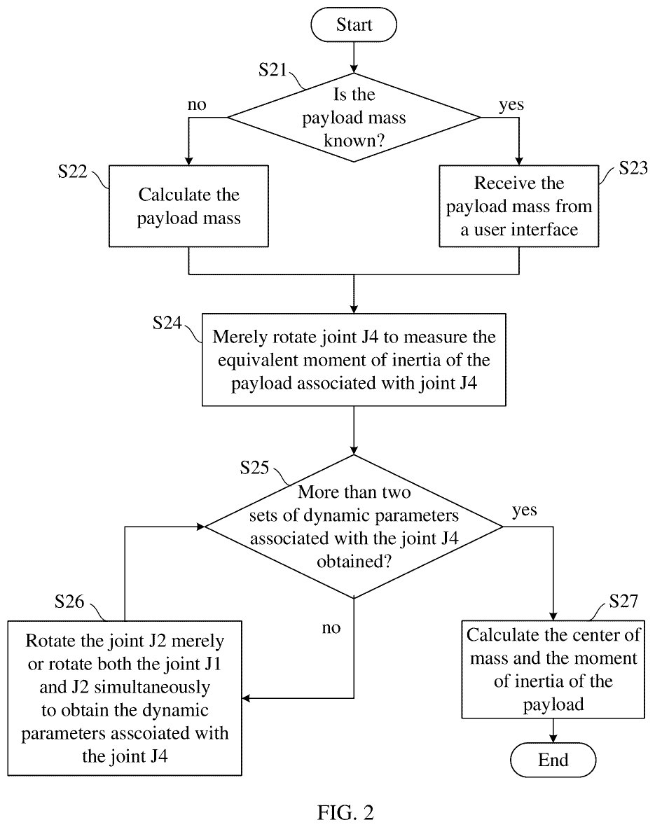

Please refer to FIG. 2, which illustrates a flowchart of a payload estimation method for the robot arm system of FIG. 1 according to an embodiment of the present disclosure. Payload estimation is used to estimate the inertial parameters of the payload, including the payload mass, the center of mass, and the moment of inertia. The method for estimating the inertial parameters of the payload comprises the following steps.
Step S21: Determine if payload mass is known. If not, proceed to step S22; if yes, proceed to step S23.
Step S22: Calculate the payload mass and proceeding to step S24.
Step S23: Receive payload mass from a user interface.
Step S24: Merely rotate the joint J4 to measure the equivalent moment of inertia of the payload associated with the joint J4.
Step S25: Determine if more than two sets of dynamic parameters associated with the joint J4 have been obtained. If not, proceed to step S26; if yes, proceed to step S27.
Step S26: Rotate the joint J2 merely or rotate both the joint J1 and J2 simultaneously to obtain the dynamic parameters associated with the joint J4.
Step S27: Calculate the center of mass and the moment of inertia of the payload.

By utilizing the estimation method of the inertial parameters of the payload shown in FIG. 2, the robot arm system 100 in FIG. 1 will be able to automatically estimate the payload mass, the center of mass, and the moment of inertia, no matter the payload mass is known or unknown. This not merely prevents user input error but also ensures the robot arm system to perform optimally. It is worth noting that experiments have shown that considering merely the dynamic equations of the most distal joint (such as the joint J4) could result in higher accuracy in estimating the center of mass. In contrast, considering the dynamic equations of all joints (such as the joints J1 to J4) leads to lower accuracy in estimating the center of mass. The present disclosure simplifies the complexity of calculating the inertial parameters and achieves higher accuracy. Further details on the estimation method are explained below.

In steps S21 and S22, when the payload mass is unknown, the theoretical or experimental methods can be used to calculate the value of the payload mass. In an embodiment based on the theoretical method, the step S22 comprises: when the spline shaft 103 carries a payload, drive the spline shaft 103 along a vertical direction Z to measure the first torque associated with the spline shaft 103; and calculate the payload mass based on equation (2). On the other hand, when the spline shaft 103 carries a payload, by fixing the joints J1, J2, and J4 at any angle, drive the spline shaft 103 to move along the vertical direction Z, the first torque T_{3,wp} (in Newton-meter) associated with the spline shaft 103 is a measurable value and can be expressed as the following equation (1):

$${T}_{3 , w p} = \frac{( {m}_{3} + {m}_{L} ) \cdot g \cdot {p}_{3}}{2 π} \qquad ( 1 )$$

wherein g presents the gravitational acceleration, p₃ presents the pitch of spline shaft 103 (in millimeters/revolution), m₃ represents the mechanism mass associated with spline shaft 103 (it can be the mass of the spline shaft or the sum of the mass of the spline shaft and a slider). The values of the gravitational acceleration g, the pitch p₃, the mechanism mass m₃, and the torque T_{3,wp} are known. By rewriting and substituting the known values into equation (1), the payload mass m_{L} can be calculated based on the following equation (2):

$${m}_{L} = 2 π \cdot \frac{{T}_{3 , wp}}{g \cdot {p}_{3}} - {m}_{3} \qquad ( 2 )$$

In addition, in an embodiment based on the experimental method, even the mechanism mass m₃ is unknown, the payload mass m_{L} can still be measured. Step S22 comprises: when the spline shaft 103 carries a payload, drive the spline shaft 103 to move along the vertical direction Z to measure a first torque associated with the spline shaft 103; when the spline shaft does not carry a payload, drive the spline shaft 103 to move along the vertical direction Z to measure a second torque associated with the spline shaft 103; and calculate the payload mass according to equation (4). Specifically, by fixing the joints J1, J2, and J4 at any angles, respectively, and driving the spline shaft 103 to move along the vertical direction Z with and without a payload. In the case of carrying a payload, the first torque associated with the spline shaft 103 can be represented by the above equation (1). In the case of not carrying a payload, the second torque T_{3,wtp} associated with the spline shaft 103 can be represented by the following equation (3):

$${T}_{3 , wtp} = \frac{{m}_{3} \cdot g \cdot {p}_{3}}{2 π} \qquad ( 3 )$$

Equations (2) and (3) can be rewritten as equation (4). By substituting the values of the gravitational acceleration g, the pitch p₃, the first torque T_{3,wp}, and the second torque T_{3,wtp} into equation (4), the payload mass m_{L} can be obtained by the following equation (4):

$${m}_{L} = 2 π \cdot \frac{{T}_{3 , wp} - {T}_{3 , wtp}}{g \cdot {p}_{3}} \qquad ( 4 )$$

In steps S21 and S23, when the payload mass is known, the robot arm system 100 receives the input value of the payload mass from a user interface. For example, the user can use a scale or get the payload mass from a CAD program, and then input the payload mass into the user interface of the robot arm system 100.

In step S24, merely rotate J4 to measure the equivalent moment of inertia I′_{ZZ,4} of the payload associated with spline shaft 103. Specifically, when spline shaft 103 carries a payload, the joints J1, J2, and J3 are fixed, and merely joint J4 is rotated, the equivalent moment of inertia I′_{ZZ,4} associated with spline shaft 103 can be expressed by the following equation (5):

$${I}_{zz , 4}^{′} = \frac{{T}_{4}}{{\ddot{θ}}_{4}} \qquad ( 5 )$$

wherein T₄ represents the torque associated with the joint J4, \ddot{θ}₄ represents the angular acceleration of the joint J4, and the torque T₄, the equivalent moment of inertia I′_{ZZ,4}, and the angular acceleration \ddot{θ}₄ are all measurable.

In step S25 and S26, rotate the joint J2 merely or rotate both the joint J1 and J2 simultaneously to obtain at least two sets of the dynamic parameters for the joint J4. Generally, the dynamic equations of a robot arm system can be derived according to the Newton-Euler or Lagrange dynamic equations, as shown in the following equation (6):

$$T = M ( θ ) \cdot \ddot{θ} + V ( θ , \dot{θ} ) + G ( θ ) + F ( \dot{θ} ) \qquad ( 6 )$$

wherein T represents the torque associated with the joints, (θ, \dot{θ}, \ddot{θ}) represents the rotation angle, the angular velocity, and the angular acceleration of the joints, M(θ) represents the inertial torque matrix, V(θ, \dot{θ}) represents the Coriolis and centrifugal matrix, G(θ) represents the gravity matrix, and F(\dot{θ}) represents the friction matrix of the joints.

When the spline shaft 103 carries a payload, the angular velocity and the angular acceleration of the joint J4 are zero, merely rotating the joint J2 or rotate both the joint J1 and J2 simultaneously, results in the friction matrix F(\dot{θ}) being zero. The dynamic equations of joint J4 can then be rewritten from equation (6) to the following equation (7):

$${[ {T}_{4} - {\ddot{θ}}_{1} \cdot {I}_{zz , 4}^{′} - {\ddot{θ}}_{2} \cdot {I}_{zz , 4}^{′} ]}_{n \times 1} = {{[ {\ddot{θ}}_{1} \cdot ( AA + B B ) + {\ddot{θ}}_{2} \cdot AA + \\ {\dot{θ}}_{1}^{2} \cdot ( CC + D D ) + 2 \cdot {\dot{θ}}_{1} \cdot {\dot{θ}}_{2} \cdot CC + {\dot{θ}}_{2}^{2} \cdot CC {\ddot{θ}}_{1} \cdot ( - CC - D D ) - \\ {\ddot{θ}}_{2} \cdot CC + {\dot{θ}}_{1}^{2} \cdot ( AA + B B ) + 2 \cdot {\dot{θ}}_{1} \cdot {\dot{θ}}_{2} \cdot AA + {\dot{θ}}_{2}^{2} \cdot AA ]}_{n \times 2} [ \begin{matrix}{C}_{x , 4} \\ {C}_{y , 4}\end{matrix} ]}_{2 \times 1} \qquad ( 7 )$$

wherein the symbol AA=cos (θ₄)·L₂·m_{L}, BB=cos (θ₂+θ₄)·L₁·m_{L}, CC=sin (θ₄)·L₂·m_{L}, and DD=sin (θ₂+θ₄)·L₁·m_{L}. (θ₁, \dot{θ}₁, \ddot{θ}₁) represents the angle, the angular velocity, and the angular acceleration of the joint J1, (θ₂, \dot{θ}₂, \ddot{θ}₂) represents the angle, the angular velocity, and the angular acceleration of the joint J2, θ₄ represents the angle of the joint J4, T₄ represents the torque associated with the joint J4, m_{L} represents the payload mass measured in step S22, I′_{ZZ,4} represents the equivalent moment of inertia measured in step S24, L₁ represents the arm length of the robot arm 101, and L₂ represents the arm length of the robot arm 102. (c_{x,4}, c_{y,4}) represents the center of mass of the payload, which is the unknown to be solved.

Given the joint J1 is fixed at angle θ₁ and the joint J4 is fixed at angle θ₄, by merely rotating the joint J2, equation (7) can be rewritten in matrix form as shown in the following equation (8):

$${[ {T}_{4} - {\ddot{θ}}_{2} \cdot {I}_{zz , 4}^{′} ]}_{n \times 1} = {{[ {\ddot{θ}}_{2} \cdot AA + {\dot{θ}}_{2}^{2} \cdot CC - {\ddot{θ}}_{2} \cdot CC + {\dot{θ}}_{2}^{2} \cdot AA ]}_{n \times 2} [ \begin{matrix}{C}_{x , 4} \\ {C}_{y , 4}\end{matrix} ]}_{( 2 \times 1 )} \qquad ( 8 )$$

wherein the symbol AA=cos (θ₄)·L₂·m_{L}, CC=sin (θ₄)·L₂·m_{L}, and T₄ represents torque associated with joint J4, m_{L} represents the payload mass measured in step S22, I′_{ZZ,4} represents the equivalent moment of inertia measured in step S24, θ₄ represents the angle of joint J4, L₂ represents the arm length of robot arm 102, (\dot{θ}₂, \ddot{θ}₂) represents the angular velocity and angular acceleration of joint J2, and the equivalent moment of inertia I′_{ZZ,4}, the arm length L₂, the angular velocity \dot{θ}₂ and the angular acceleration \ddot{θ}₂ are data can be measured or estimated in the robot arm system 100. By substituting these known data (dynamic parameters) into equation (8), a first equation for the center of mass (c_{x,4}, c_{y,4}) of the payload can be obtained, where the center of mass (c_{x,4}, c_{y,4}) is the unknown to be solved.

After the first execution of step S26, step S26 further comprises: rotate the joint J4 from the first angle θ₄ to a second angle; and merely rotate the joint J2 to obtain a second set of dynamic parameters for the joint J4. By substituting the second set of dynamic parameters into equation (7) or (8), a second equation of the center of mass (c_{x,4}, c_{y,4}) of the payload can be obtained. By using the least squares method to solve the two equations of the center of mass (c_{x,4}, c_{y,4}), the center of mass (c_{x,4}, c_{y,4}) of the payload can be estimated. Experimental results show that when the difference between the first angle and the second angle of the joint J4 is greater than or equal to 45 degrees, the correlation between the two sets of dynamic parameters can be reduced, thereby resulting in better estimated results. It should be understood that because there are two unknowns to be solved, namely the center of mass (c_{x,4}, c_{y,4}), at least two equations are needed to obtain a unique solution for both unknowns. However, in other embodiments, joint J4 can be fixed at multiple other angles to obtain multiple equations the center of mass (c_{x,4}, c_{y,4}), based on equation (7) or (8), which can then be used in conjunction with the least squares method to estimate the center of mass of the payload (c_{x,4}, c_{y,4}), thus improving accuracy.

For example, when merely rotating the joint J2 or rotating the joint J1 and J2 simultaneously, assuming the joint J4's first angle θ₄=A, the joint J4's second angle θ₄=B, during the movement process with the joint J4 fixed at the first angle θ₄=A, n data [Y_{A}]_{n×1} are measured, and during the movement process with the joint J4 fixed at the second angle θ4=B, m data [Y_{B}]_{m×1} are measured. When the measured data are substituted into equation (8), it can be organized into the form of Y=Xβ, as shown in the following equation (9):

$${[ \begin{matrix}{Y}_{A} \\ {Y}_{B}\end{matrix} ]}_{( n + m ) \times 1} = {{[ \begin{matrix}{X}_{A} \\ {X}_{B}\end{matrix} ]}_{( n + m ) \times 2} [ \begin{matrix}{C}_{x , 4} \\ {C}_{y , 4}\end{matrix} ]}_{( 2 \times 1 )} \qquad ( 9 )$$

And, the center of mass of the payload (c_{x,4}, c_{y,4}) in equation (9) can be calculated via the least squares method.

In another embodiment of the present disclosure, in step S26, the joints J1 and J2 can be simultaneously rotated to obtain the dynamic parameters of the joint J4, where the dynamic parameters include any known data that needs to be substituted into equation (7). Specifically, consider that the spline shaft 103 carries a payload, the joint J3 is fixed at a certain height, the joint J4 is fixed at a first angle, and the joints J1 and J2 are rotated simultaneously. After performing step S26 twice, two sets of the dynamic parameters of the joint J4 can be obtained. By substituting the two sets of dynamic parameters into equation (7), two equations of the center of mass (c_{x,4}, c_{y,4}) of the payload can be derived. Utilizing the least squares method to solve for these two equations, the center of mass (c_{x,4}, c_{y,4}) of the payload can be estimated.

In steps S25 and S27, once more than two sets of the dynamic parameters of the joint J4 have been obtained, calculate the moment of inertia I′_{ZZ,4} of the payload based on the payload mass m_{L}, the equivalent moment of inertia I′_{ZZ,4}, and the center of mass (c_{x,4}, c_{y,4}). Specifically, by using the parallel axis theorem, the moment of inertia I_{ZZ,4} of the payload can be obtained by the following equation (10):

$${I}_{zz , 4} = {I}_{zz , 4}^{′} - {m}_{L} \cdot ( {c}_{x , 4}^{2} + {c}_{y , 4}^{2} ) \qquad ( 10 )$$

wherein (c_{x,4}, c_{y,4}) is the center of mass of the payload measured in step S23, I′_{ZZ,4} is the equivalent moment of inertia of the payload measured in step S22, and m is the payload mass measured in step S21. As a result, all the inertia parameters of the payload have been obtained.

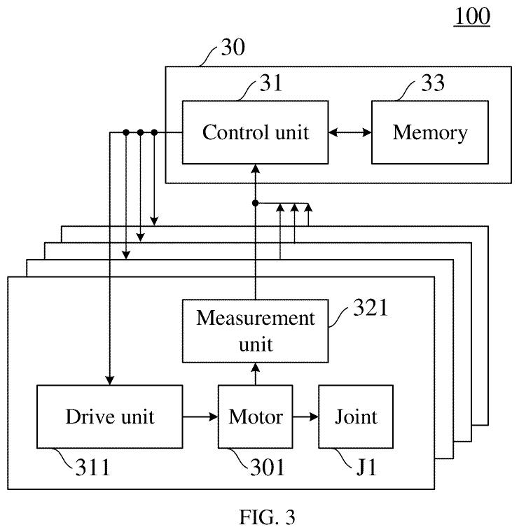

Please refer to FIG. 3, which illustrates the functional block diagram of the robot arm system 100 according to an embodiment of the present disclosure. The robot arm system 100 comprises a control unit 31, a plurality of drive units 311, a plurality of measurement units 321, a plurality of motors 301, and a plurality of joints J1˜J4, and a memory 33. The control unit 31 is coupled to the plurality of drive units 311, the plurality of measurement units 321, and the memory 33, and is configured to generate control signals to the plurality of drive units 311 for controlling the motion of the joints J1˜J4. The control unit 31 is also configured to estimate the inertial parameters of the payload based on receiving measurement data from the plurality of measurement units 321. In one embodiment, the control unit 31 and the memory 33 may be integrated within the robot arm system, or be an external electronic device 30, which can be a Programmable Logic Controller (PLC), a Human-Machine Interface (HMI), a desktop computer, or a laptop, etc.

The method for controlling the motion of each joint J1˜J4 is the same. Taking the joint J1 as an example, the drive unit 311 is coupled to the control unit 31, which is configured to generate drive signals to the motor 301 based on the control signals. The motor 301 is coupled to the joint J1 and is configured to drive the joint J1 to rotate or fix at a specific angle based on the drive signals. The measurement unit 321 is coupled to the motor 301 and is configured to measure the rotation angle, the angular velocity, and the angular acceleration of the motor 301, and feed back the data to the control unit 31. The memory 33 is coupled to the control unit and is configured to store a program, designed according to the payload estimation method shown in FIG. 2, to instruct the control unit 31 to execute the steps of the payload estimation method shown in FIG. 2 (such as generating relevant control signals, receiving feedback data, calculating the torque value of motor 301 based on the feedback data, etc.), in order to estimate the inertial parameters of the payload. It should be understandable that, for the sake of simplicity, not all components of the robot arm system 100 are shown in FIG. 3.

The robot arm system has many mechanical parameters. Regarding the payload mass, the moment of inertia, and the center of mass to be estimated, the estimation method provided by the present disclosure merely requires to involve the dynamic equations of the joint J4 to effectively estimate the inertial parameters of the payload, with the advantage of simplifying the calculation. Furthermore, the automatic estimation mechanism provided by the present disclosure can reduce the risk of inaccurate human input to ensure that the robot arm to perform at optimal performance.

The aforementioned details represent merely specific implementations of the present disclosure. However, the protection scope of the present disclosure is not limited thereto. Any modifications or replacements that can be easily devised by those skilled in the art within the technical scope of the present disclosure should all fall within the protection scope of the present disclosure. Consequently, the protection scope of the present disclosure should be defined by the protection scope of the appended claims.

What is claimed is:

1. A payload estimation method for a robot arm system, which comprises a first robot arm, a second robot arm, a spline shaft, a first joint, a second joint, a third joint, and a fourth joint, and the spline shaft is used to carry a payload, the method comprising:
step (a): calculating or receiving a payload mass;
step (b): rotating merely the fourth joint to drive the spline shaft and the payload to rotate, in order to measure the equivalent moment of inertia of the payload associated with the fourth joint;
step (c): rotating merely the second joint or simultaneously rotating both the first joint and the second joint to measure the dynamic parameters of the payload associated with the fourth joint, and repeating step (c) at least two times to obtain at least two sets of dynamic parameters;
step (d): substituting at least two sets of the dynamic parameters into the corresponding dynamic equations of the fourth joint, resulting in at least two equations relating to the center of mass for calculating the center of mass of the payload; and
step (e): calculating the moment of inertia of the payload based on the payload mass, the equivalent moment of inertia, and the center of mass of the payload.

2. The method according to claim 1, wherein the step (a) comprises:
when the payload mass is unknown and the spline shaft carries the payload, driving the spline shaft to move along a vertical direction to measure a first torque associated with the spline shaft; and
calculating the payload mass based on the following equation:
$${m}_{L} = 2 π \cdot \frac{{T}_{3 , wp}}{g \cdot {p}_{3}} - {m}_{3}$$
wherein m_{L} represents the payload mass, T_{3,wp} represents the first torque, g represents a gravitational acceleration, p₃ represents the pitch of the spline shaft, and m₃ represents the mechanism mass associated with the spline shaft.

3. The method according to claim 1, wherein the step (a) comprises:
when the payload mass is unknown and the spline shaft carries the payload, driving the spline shaft to move along a vertical direction to measure a first torque associated with the spline shaft;
when the payload mass is unknown and the spline shaft does not carry the payload, driving the spline shaft to move along the vertical direction to measure a second torque associated with the spline shaft; and
calculating the payload mass based on the following equation:
$${m}_{L} = 2 π \cdot \frac{{T}_{3 , wp} - {T}_{3 , wtp}}{g \cdot {p}_{3}}$$
wherein m_{L} represents the payload mass, T_{3,wp} represents the first torque with the payload, T_{3,wtp} represents the second torque without the payload, g represents the gravitational acceleration, and p₃ represents the pitch of the spline shaft.

4. The method according to claim 1, wherein the step (a) comprises:
when the payload mass is known, receiving the payload mass from a user interface.

5. The method according to claim 1, wherein the step (b) comprises:
based on the following equation, calculating the equivalent moment of inertia of the payload associated with the fourth joint:
$${I}_{zz , 4}^{′} = \frac{{T}_{4}}{{\ddot{θ}}_{4}}$$
wherein I′_{ZZ,4} represents the equivalent moment of inertia, T₄ represents the torque associated with the spline shaft, and \ddot{θ}₄ represents the angular acceleration of the fourth joint.

6. The method according to claim 1, wherein after the first execution of the step (c), the step (c) comprises:
rotating the fourth joint from a first angle to a second angle; and
merely rotating the second joint or rotating both the first joint and the second joint simultaneously;
when performing the step (c) for the first time, the fourth joint is fixed at the first angle, and the first angle differs from the second angle by 45 degrees or more.

7. The method according to claim 1, wherein when, in the step (c), rotating merely the second joint or simultaneously rotating both the first joint and the second joint, the dynamic equations of the fourth joint are given as follows:
$${[ {T}_{4} - {\ddot{θ}}_{1} \cdot {I}_{zz , 4}^{′} - {\ddot{θ}}_{2} \cdot {I}_{zz , 4}^{′} ]}_{n \times 1} = {{[ {\ddot{θ}}_{1} \cdot ( AA + B B ) + {\ddot{θ}}_{2} \cdot AA + \\ {\dot{θ}}_{1}^{2} \cdot ( CC + D D ) + 2 \cdot {\dot{θ}}_{1} \cdot {\dot{θ}}_{2} \cdot CC + {\dot{θ}}_{2}^{2} \cdot CC {\ddot{θ}}_{1} \cdot ( - CC - D D ) - \\ {\ddot{θ}}_{2} \cdot CC + {\dot{θ}}_{1}^{2} \cdot ( AA + B B ) + 2 \cdot {\dot{θ}}_{1} \cdot {\dot{θ}}_{2} \cdot AA + {\dot{θ}}_{2}^{2} \cdot AA ]}_{n \times 2} [ \begin{matrix}{C}_{x , 4} \\ {C}_{y , 4}\end{matrix} ]}_{2 \times 1}$$
wherein the symbol AA=cos (θ₄)·L₂·m_{L}, BB=cos (θ₂+θ₄)·L₁·m_{L}, CC=sin (θ₄)·L₂·m_{L}, and DD=sin (θ₂+θ₄)·L₁·m_{L};
wherein T₄ represents the torque associated with the fourth joint, I′_{ZZ,4} represents the equivalent moment of inertia of the fourth joint, (\dot{θ}₁, \ddot{θ}₁) represents the angular velocity and angular acceleration of the first joint, (θ₂, \dot{θ}₂, \ddot{θ}₂) represents the angle, angular velocity, and angular acceleration of the second joint, θ₄ represents the angle of the fourth joint, L₁ represents the arm length of the first robot arm, L₂ represents the arm length of the second robot arm, m_{L} represents the payload mass, and (c_{x,4}, c_{y,4}) represents the center of mass.

8. The method according to claim 7, wherein the step (d) comprises:
using a least squares method to solve the at least two equations relating to the center of mass in order to calculate the center of mass of the payload.

9. The method according to claim 7, wherein the step (e) comprises:
applying the payload mass, the equivalent moment of inertia, and the center of mass to a parallel axis theorem in order to calculate the moment of inertia of the payload based on the following equation:
$${I}_{zz , 4} = {I}_{zz , 4}^{′} - {m}_{L} \cdot ( {c}_{x , 4}^{2} + {c}_{y , 4}^{2} )$$
wherein I′_{ZZ,4} represents the moment of inertia, I′_{ZZ,4} represents the equivalent moment of inertia, m_{L} represents the payload mass, and (c_{x,4}, c_{y,4}) represents the center of mass.

10. A robot arm system, comprising:
a base;
a first robot arm with one end pivotally connected to the base through a first joint;
a second robot arm with one end pivotally connected to the other end of the first robot arm through a second joint;
a spline shaft installed at the other end of the second robot arm, wherein an end of the spline shaft is used to carry a payload;
a third joint for controlling the height of the spline shaft;
a fourth joint for rotating the spline shaft; and
a control unit configured to execute a payload estimation method according to claim 1.

11. The system according to claim 10, the system further comprising:
a plurality of motors coupled to the first, second, third, and fourth joints respectively, configured to drive the first, second, third, and fourth joints based on a plurality of driving signals;
a plurality of drive units coupled to the control unit and configured to generate the plurality of drive signals to the plurality of motors based on a plurality of control signals from the control unit; and
a plurality of measuring units coupled to the plurality of motors, respectively, to measure and send the dynamic parameters of the motors back to the control unit;
wherein the control unit is coupled to the plurality of drive units and the plurality of measuring units to generate the plurality of control signals to the plurality of drive units and receive the dynamic parameters.

12. An electronic device, comprising:
a control unit; and
a memory coupled to the control unit, configured to store a program code that instructs the control unit to execute a payload estimation method according to claim 1.
